(19) United States
(12) Patent Application Publication
(10) Pub. No.: US 2006/0289501 A1
(43) Pub. Date: Dec. 28, 2006

(54) Method of manufacturing honeycomb structure

(75) Inventors: Taishi Michiwaki, Nagoya-city (JP); Yuji Ito, Toyota-city (JP); Yukihisa Wada, Nisshin-city (JP)

Correspondence Address: OLIFF & BERRIDGE, PLC, P.O. BOX 19928, ALEXANDRIA, VA, 22320, US

(73) Assignee: NGK INSULATORS, LTD., NAGOYA CITY (JP)

(21) Appl. No.: 11/436,034

(22) Filed: May 18, 2006

(30) Foreign Application Priority Data
May 18, 2005 (JP) 2005-144895

(51) Int. Cl. H05B 6/80

(52) U.S. Cl. 219/687

(57) ABSTRACT

There is disclosed a honeycomb structure manufacturing method which is capable of efficiently and inexpensively manufacturing a honeycomb structure for preferable use in a filter for trapping particulates in an exhaust gas or the like by use of a long-life grinding member whose satisfactory grinding performance is retained for a long time. The method includes the step of: working an outer periphery of a coarsely shaped honeycomb structure 20 made of a porous ceramic by use of a grinding member 10 to obtain a honeycomb structure 30 having a predetermined shape, wherein diamond abrasive grains of the grinding member 10 have a grain size of 40 to 150 mesh (JIS B 4130 standard) and a concentration degree of 80 or more, and the surfaces of the diamond abrasive grains are coated with at least one selected from the group consisting of Ti, Ni, and Cr.

### BACKGROUND OF THE INVENTION

1. Field of the Invention

The present invention relates to a method of manufacturing a honeycomb structure, more particularly to a honeycomb structure manufacturing method which is capable of efficiently and inexpensively manufacturing a honeycomb structure for preferable use in a filter for trapping particulates in an exhaust gas or the like by use of a long-life grinding member whose satisfactory grinding performance is retained for a long time.

2. Description of the Related Art

A honeycomb structure is used in a filter for trapping particulates in an exhaust gas or the like. The honeycomb structure for use in such purpose has a problem that a temperature distribution in the honeycomb structure becomes non-uniform owing to a rapid temperature change of the exhaust gas or locally generated heat, and cracks are generated in the structure. Especially when the structure is used as a filter (hereinafter sometimes referred to as the “DPF”) for trapping particulate substances (particulates) in an exhaust gas from a diesel engine, accumulated carbon particulates need to be burnt and removed, thereby regenerating the filter. In this case, since locally raised temperature cannot be avoided, the cracks are easily generated by a large thermal stress.

To solve the problem, a plurality of divided segments of the honeycomb structure are bonded by a bonding material to form a coarsely shaped honeycomb structure, and an outer periphery of the structure is worked into a predetermined shape to manufacture the honeycomb structure. Specifically, the honeycomb segments are obtained in which a plurality of cells functioning as fluid channels defined by porous ceramic partition walls functioning as filters are juxtaposed in parallel with one another in a central axis direction of each segment. The resultant honeycomb segments are integrated to obtain the coarsely shaped honeycomb structure, and the outer periphery of the resultant coarsely shaped honeycomb structure is worked into a predetermined shape to manufacture the structure. Since the honeycomb structure manufactured in this manner is contained and used in a can member made of a metal or the like, the structure needs to have a shape corresponding to an internal shape of the can member made of the metal or the like. That is, the outer periphery of the coarsely shaped honeycomb structure needs to be worked into the shape corresponding to the internal shape of the metal-made can member in which the structure is to be contained, thereby manufacturing the structure.

As a method of working the outer periphery of such coarsely shaped honeycomb structure to manufacture the honeycomb structure, there is known a method of working the outer periphery by use of a grinder such as a cam grinder or a cylindrical grinder. There is proposed a method of shaving a porous ceramic material into various sizes and shapes by use of a grinding member provided with a grinding wheel layer in a circumferential portion of a disc (hub) to manufacture the honeycomb structure (see Patent Document 1). The grinding member for use in this method has, for example, the grinding wheel layer including diamond abrasive grains which are dispersed and fixed in a bonding material. This method has a problem that a wearing speed of the grinding member, especially the bonding material is high, the diamond abrasive grains drop off without being substantially worn, a grinding capability degrades, a life of the grinding member as a tool is short, and the member is not advantageous in respect of costs. To prevent such drop-off of the diamond abrasive grains from the bonding material, there are disclosed diamond abrasive grains whose surfaces are all coated with a carbide of a transition metal and whose bonding force with respect to a metal based bonding material has been improved (see Patent Document 2).

[Patent Document 1] Japanese Patent Application Laid-Open No. 2001-191240

[Patent Document 2] Japanese Patent Application Laid-Open No. 2003-55649

However, the grinding member using such diamond abrasive grains can exhibit an effect in preventing the drop-off of the diamond abrasive grains from the bonding material to a certain degree. However, the grinding member is not necessarily sufficiently satisfactory, because the wearing speed of the bonding material becomes remarkably high on working conditions that an amount, per certain time, of the outer periphery of the coarsely shaped honeycomb structure to be ground by a dry process is large, and a working object is similar to an abrasive as in a case where the outer periphery is worked into the predetermined shape to thereby manufacture the honeycomb structure.

### SUMMARY OF THE INVENTION

The present invention has been developed in view of the above-described problem, and an object is to provide a honeycomb structure manufacturing method which is capable of efficiently and inexpensively manufacturing a honeycomb structure for preferable use in a filter for trapping particulates in an exhaust gas or the like by use of a long-life grinding member whose satisfactory grinding performance is retained for a long time.

The present invention provides the following method of manufacturing a honeycomb structure.

[1] A method of manufacturing a honeycomb structure, comprising the step of: working an outer periphery of a coarsely shaped honeycomb structure made of a porous ceramic by use of a grinding member including a grinding wheel layer in which diamond abrasive grains are contained and fixed in a bonding material having a predetermined shape to obtain the honeycomb structure having a predetermined shape,

wherein the diamond abrasive grains of the grinding member have a grain size of 40 to 150 mesh (JIS B 4130 standard) and a concentration degree of 80 or more, and the surfaces of the diamond abrasive grains are coated with at least one selected from the group consisting of Ti, Ni, and Cr.

[2] The method of manufacturing the honeycomb structure according to the above [1], wherein the outer periphery of the coarsely shaped honeycomb structure is worked by a high-speed dry process at a rotation speed (peripheral speed) of 30 to 150 m/sec.

[3] The method of manufacturing the honeycomb structure according to the above [1] or [2], further comprising the steps of:

obtaining a plurality of honeycomb segments in which a plurality of cells are arranged in a central axis direction of each honeycomb segment, the cells forming fluid channels defined by porous ceramic partition walls functioning as filters;

integrating the resultant plurality of honeycomb segments to obtain the coarsely shaped honeycomb structure; and

working the outer periphery of the resultant coarsely shaped honeycomb structure to obtain the honeycomb structure having the predetermined shape.

[4] The method of manufacturing the honeycomb structure according to any one of the above [1] to [3], wherein the outer periphery of the coarsely shaped honeycomb structure is worked by rotating the coarsely shaped honeycomb structure around a central axis of the structure, and pressing the grinding member onto an outer peripheral surface of the coarsely shaped honeycomb structure.

[5] The method of manufacturing the honeycomb structure according to any one of the above [1] to [4], wherein the outer periphery of the coarsely shaped honeycomb structure is worked so that a section of the structure cut along a plane perpendicular to the central axis of the structure is formed into a circular shape, an oblong shape, an elliptic shape, a triangular shape, a polygonal shape, or a shape obtained by transforming a part of one of these shapes.

As described above, according to the present invention, there is provided a honeycomb structure manufacturing method which is capable of efficiently and inexpensively manufacturing a honeycomb structure for preferable use in a filter for trapping particulates in an exhaust gas or the like by use of a long-life grinding member whose satisfactory grinding performance is retained for a long time.

### BRIEF DESCRIPTION OF THE DRAWINGS

FIG. 1 is an explanatory view schematically showing one embodiment of a method of manufacturing a honeycomb structure of the present invention;

FIG. 2 is an explanatory view schematically showing a typical example of a grinding member for use in the present invention;

FIG. 3 is an explanatory view schematically showing an example of the honeycomb structure obtained by the honeycomb structure manufacturing method of the present invention; and

FIG. 4 is an explanatory view schematically showing another embodiment of the honeycomb structure manufacturing method of the present invention.

### DESCRIPTION OF THE PREFERRED EMBODIMENT

There will be described hereinafter an embodiment of a method of manufacturing a honeycomb structure of the present invention in detail with reference to the drawings.

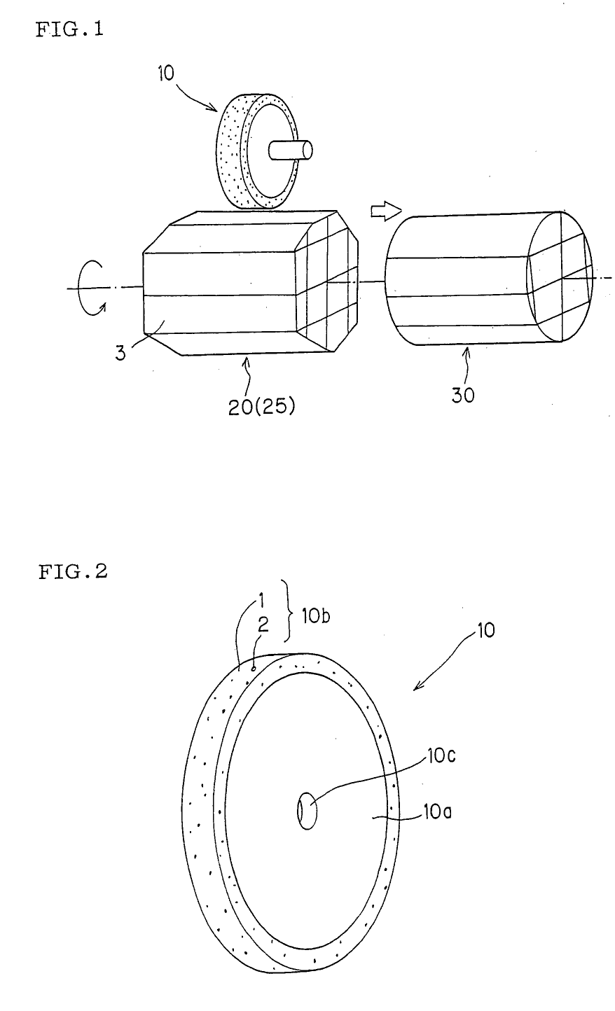

As shown in FIG. 1, a honeycomb structure manufacturing method of the present invention is a honeycomb structure manufacturing method of working an outer periphery of a coarsely shaped honeycomb structure 20 made of a porous ceramic by use of a grinding member 10 to obtain a honeycomb structure 30 having a predetermined shape. As the grinding member 10, there is used a member including diamond abrasive grains having a grain size of 40 to 150 mesh (JIS B 4130 standard) and a concentration degree of 80 or more. The surfaces of the diamond abrasive grains are coated with at least one selected from the group consisting of Ti, Ni, and Cr. In the present invention, as one typical example of the grinding member 10, the grinding member 10 shown in FIG. 2 is usable.

As shown in FIG. 2, in the method of manufacturing the honeycomb structure in the present invention, as the grinding member 10, there can be used the grinding member 10 including a grinding wheel layer 10b in which diamond abrasive grains 2 are dispersed and fixed in a bonding material 1 having a predetermined shape. The diamond abrasive grains 2 have a grain size of 40 to 150 mesh (JIS B 4130 standard) and a concentration degree of 80 or more. The surfaces of the diamond abrasive grains 2 are coated with at least one selected from the group consisting of Ti, Ni, and Cr. In the grinding member 10 for use in the present invention, corners of a circumferential portion of the grinding wheel layer 10b are preferably chamfered (C or R). It is to be noted that in FIG. 2, reference numeral 10a denotes a disc (hub), and 10c denotes a rotation shaft connecting hole.

Examples of the bonding material 1 for use in the grinding member 10 include a metal bond, a resin bond, an electrodeposition bond, and a vitrified bond. Above all, the metal bond and the electrodeposition bond are preferable because they have an excellent resistance to wear.

Examples of a shape of the grinding member 10 include a wheel shape and a cup shape. The whole shape preferably has a diameter of 150 to 500 mm. Specifically, the grinding member 10 is preferably constituted by disposing the grinding wheel layer 10b on the surface of the circumferential portion of the hub 10a made of, for example, a stainless steel, a carbon steel material and having a diameter of 150 to 500 mm. In the grinding wheel layer, the diamond abrasive grains 2 are dispersed and fixed in the bonding material 1. The grinding wheel layer 10b has a thickness of, for example, preferably 0.1 to 10 mm, more preferably 3 to 10 mm.

The diamond abrasive grains 2 for use in the grinding member 10 have a grain size of usually 40 to 150 mesh (JIS B 4130 standard), preferably 40 to 120 mesh, more preferably 60 to 100 mesh. Here, the grain size means fineness of abrasive grains. If the grain size is below 40 mesh, the grains are easily crushed. If the grain size is above 150 mesh, the grains are easily removed.

The diamond abrasive grains 2 for use in the grinding member 10 have a concentration degree of usually 80 or more, preferably 100 or more, more preferably 150 or more. Here, the concentration degree is a weight (concentration degree 100=4.4 carats/cm²) of diamond abrasive grains per unit area. If the concentration degree is below 80, the bonding material is easily worn.

The surfaces of the diamond abrasive grains 2 for use in the grinding member 10 are coated with at least one selected from the group consisting of Ti, Ni, and Cr as described above. Above all, the surfaces are preferably coated with Ti for a reason that a bonding force is strengthened.

In the present invention, the outer periphery of the coarsely shaped honeycomb structure 20 is worked by a high-speed dry process at a rotation speed (peripheral speed) of preferably 30 to 150 m/sec, more preferably 40 to 150 m/sec. If the rotation speed (peripheral speed) is below 30 m/sec, the abrasive grains are sometimes worn. If the speed is above 150 m/sec, the bonding material is sometimes worn early.

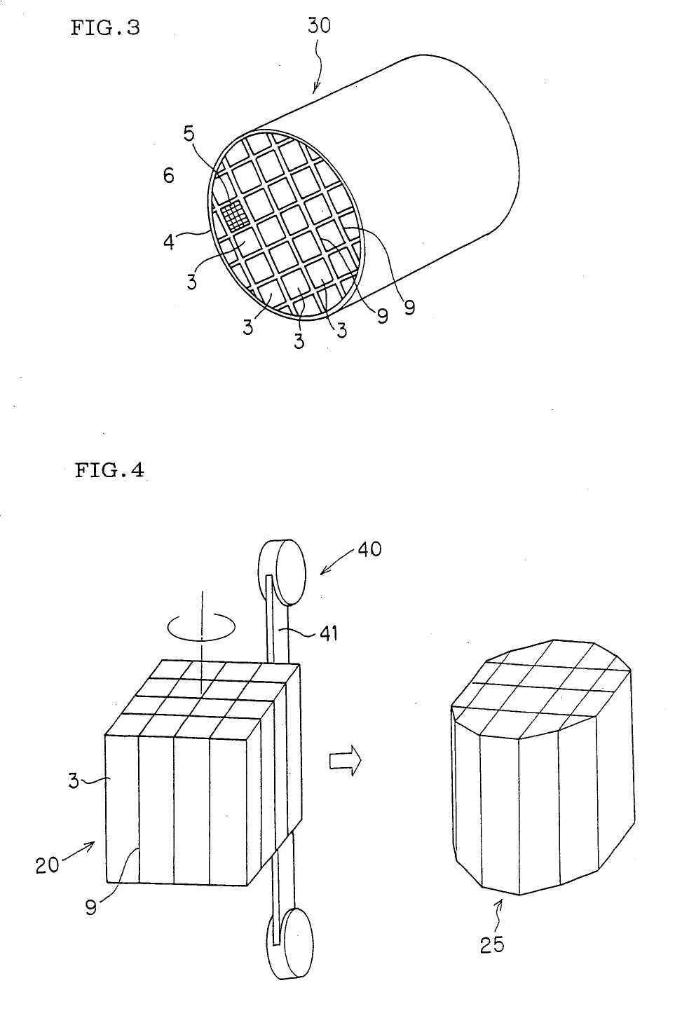

As shown in FIG. 3, to obtain a honeycomb structure 30 in the present invention, honeycomb segments 3 are integrated to obtain the coarsely shaped honeycomb structure 20 (see FIG. 1). In the honeycomb segments, a plurality of cells 5 are juxtaposed in a central axis direction of each segment. The cells function as fluid channels defined by porous ceramic partition walls 6 which function as filters. Furthermore, an outer peripheral surface of the coarsely shaped honeycomb structure 20 is worked to obtain the honeycomb structure 30 having an outer peripheral surface 4 having a predetermined shape.

As shown in FIG. 1, as a method of working the outer periphery of the coarsely shaped honeycomb structure 20, for example, there is a method of rotating the coarsely shaped honeycomb structure 20 around the central axis of the structure, and pressing the grinding member 10 onto the outer peripheral surface of the coarsely shaped honeycomb structure 20.

In the present invention, the outer periphery of the coarsely shaped honeycomb structure 20 is preferably worked so that a section of the structure cut along a plane perpendicular to a central axis of the structure is formed into a circular shape, an oblong shape, an elliptic shape, a triangular shape, a polygonal shape, or a shape obtained by transforming a part of one of these shapes so as to give a shape corresponding to an internal shape of a metal-made can member or the like in which the structure is to be contained or a shape of a section of a coarsely worked honeycomb structure 25 (see FIG. 4) described later.

As shown in FIG. 4, before working the outer periphery of the coarsely shaped honeycomb structure 20 by the grinding member 10 (see FIG. 1), the coarsely shaped honeycomb structure 20 is coarsely worked by a bead saw 40 including a linear cutter 41 to obtain the coarsely worked honeycomb structure 25 (having a shape larger than that of the finally obtained honeycomb structure 30 (see FIG. 1)), and the outer periphery of this coarsely worked honeycomb structure 25 is preferably finished by the grinding member 10. This is effective especially in a case where the shape of the coarsely shaped honeycomb structure 20 is easily broken by the working by the grinding member 10 from an outer peripheral side (e.g., the structure has a rectangular parallelepiped shape constituted by integrating the plurality of honeycomb segments 3). That is, the working is thus divided into two stages: a first stage of coarsely working the outer periphery of the easily broken coarsely shaped honeycomb structure 20 by use of the bead saw capable of working the outer periphery without breaking the outer periphery to form the coarsely worked honeycomb structure 25 whose working allowance has been reduced; and a second stage of finishing the coarsely worked honeycomb structure 25 by the grinding member 10 attached to a cam grinder to obtain the honeycomb structure 30. Since the working allowance is decreased, the generation of breakage can be prevented beforehand. Moreover, the working of the outer periphery can be realized with a high precision.

There is not any special restriction on a method of forming the honeycomb segment 3. A general method of manufacturing the honeycomb structure may be used. The honeycomb structure may be manufactured by, for example, the following method.

As a raw material of the honeycomb segment, from a viewpoint of strength, thermal resistance or the like, there is used a material whose main component (this means a component which occupies 80 mass % or more of the material and which forms a main crystal phase) is at least one ceramic selected from the group consisting of silicon carbide, silicon nitride, cordierite, alumina, mullite, zirconia, zirconium phosphate, aluminum titanate, and titania; an Fe—Cr—Al-based metal; a nickel-based metal; metal Si; or metal SiC. To this raw material, there is added: a binder such as methyl cellulose or hydroxypropoxyl methyl cellulose; a surfactant; water or the like, thereby preparing a plastic clay.

This clay is, for example, extruded to form a honeycomb formed body in which a plurality of cells 5 forming fluid channels defined by porous partition walls 6 are juxtaposed in an axial direction as shown in FIG. 3. This body is dried with, for example, microwave or hot air, and fired to thereby manufacture the honeycomb segments 3 shown in FIG. 3.

There is not any special restriction on a cell density (the number of cells per unit sectional area) of the honeycomb segment 3, but the cell density is, for example, preferably 0.9 to 310 cells/cm² (6 to 2000 cells/square inch). There is not any restriction on a cell sectional shape (cell shape), but examples of the shape include: polygonal shapes such as a triangular shape, a quadrangular shape, and a hexagonal shape; a circular shape; an elliptic shape; and a corrugated shape. Above all, a triangular shape, a quadrangular shape, and a hexagonal shape are preferable from a manufacturing viewpoint. There is not any special restriction on a thickness of the partition wall, but the thickness is, for example, preferably 50 to 2000 μm.

Moreover, there is not any special restriction on a shape of the honeycomb segment 3, but examples of the shape include a columnar shape (square pole shape) having a quadrangular sectional shape as shown in FIG. 3. The segment may have a columnar shape having a fan-shaped section.

After manufacturing the honeycomb segments 3, these honeycomb segments 3 can be bonded by, for example, an adhesive 9, and integrated to form the coarsely shaped honeycomb structure 20 (see FIG. 1).

It is to be noted that there is not any special restriction on a shape of the coarsely shaped honeycomb structure 20 constituted by integrating the honeycomb segments 3, but examples of the shape include a columnar (rectangular parallelepiped) shape having a quadrangular section as shown in FIG. 3. In addition, the structure may have a columnar shape having a circular, oblong, elliptic, polygonal, or triangular section.

In a typical example of a method of forming the coarsely shaped honeycomb structure 20, the adhesive 9 is applied to at least one of facing bond surfaces of two honeycomb segments 3 to be integrated, and the bond surfaces are bonded to each other. In this case, the honeycomb segments 3 to be bonded are preferably pressed and bonded onto each other, so that a satisfactory bonding force can be obtained easily. In this case, a spacer made of, for example, an inorganic or organic material may be disposed between the honeycomb segments 3 so as to obtain the honeycomb structure 30 in which a thickness of the adhesive layer 9 between the honeycomb segments 3 is set to be uniform and there are less defects in dimensional precisions.

There is not any special restriction on a type of the adhesive 9, and there may be used a known adhesive suitable for the material of the honeycomb segment 3. The adhesive is preferably mixed with an inorganic fiber such as a ceramic fiber, inorganic powder such as ceramic powder, an organic or inorganic binder or the like. Furthermore, the adhesive may contain a sol-like substance such as Si sol. A plurality of types of adhesives may be used, or an adhesive layer may be formed of a plurality of layers. When the adhesive is further dried and/or fired, a larger bonding force can be obtained depending on the type of the adhesive. There is not any special restriction on a thickness of the adhesive layer, but the thickness is, for example, preferably 0.1 to 3.0 mm.

Moreover, in a case where the honeycomb structure is used in a filter, especially a DPF or the like, openings of the cells 5 are preferably alternately plugged so that end faces of the structure have a checkered pattern. To plug the cell openings with a plugging material, cells which are not to be closed are masked, and a slurried material is applied to each opening end face of the honeycomb segment, dried, and thereafter fired. The plugging material can be preferably selected from the group consisting of the above-described preferable examples of the raw material of the honeycomb segment, but the same material as that for use in the honeycomb segment is preferably used.

Furthermore, a catalyst may be carried by the coarsely shaped honeycomb structure or the honeycomb structure. There is not any special restriction on this method, but examples of the method include a method of wash-coating the structure with a catalyst slurry, and drying and firing the structure to thereby allow the structure to carry the catalyst. This step may be performed at any time after forming the honeycomb segment. In a case where the honeycomb structure is used as a catalyst carrier in an internal combustion engine, a boiler, a chemical reaction device, a reformer for a fuel battery or the like, the honeycomb structure preferably carries a metal having a catalyst capability. Typical examples of the metal having the catalyst capability include Pt, Pd, and Rh. At least one of these metals is preferably carried by the honeycomb structure.

### EXAMPLES

There will be described a method of manufacturing the honeycomb structure of the present invention in more detail in accordance with examples.

### Example 1

In grinding of a coarsely shaped honeycomb structure 20 (coarsely worked honeycomb structure 25) shown in FIG. 1 to obtain a honeycomb structure 30, the grinding was performed by operating a wheel grinding member having an outer diameter of 350 mm at a peripheral speed of 120 m/s. The member was constituted by disposing a grinding wheel layer having a thickness of 5 mm on the surface of a circumferential portion of a hub having a diameter of 340 mm and made of carbon steel, stainless steel or the like. In the layer, diamond abrasive grains whose surfaces were coated with Ti having a thickness of 8 to 50 μm were dispersed and fixed in a bonding material made of a metal bond. The grains had a grain size of 100 mesh and a concentration degree of 100 (see Table 5).

### Examples 2 to 7, Comparative Examples 1 to 25

Honeycomb structures were manufactured in the same manner as in Example 1 except that a diamond abrasive grain concentration degree, grain size, grinding wheel peripheral speed, and diamond coating of a grinding member of Example 1 were changed as shown in Tables 1 to 5.

TABLE 1

| | Comparative | Comparative | Comparative | Comparative | Comparative |
|---|---|---|---|---|---|
| | Example 1 | Example 2 | Example 3 | Example 4 | Example 5 |
| Concentration degree | 70 | 100 | 100 | 100 | 100 |
| (100 = 4.4 carats/cm²) | | | | | |
| Grain size (abrasive | 100 | 40 | 100 | 180 | 100 |
| grain size #) | | | | | |
| Grinding wheel | 120 | 120 | 20 | 120 | 160 |
| peripheral speed (m/s) | | | | | |
| Diamond coating (Ti) | None | None | None | None | None |

TABLE 2

| | Comparative | Comparative | Comparative | Comparative | Comparative | Comparative | Comparative |
|---|---|---|---|---|---|---|---|
| | Example 6 | Example 7 | Example 8 | Example 9 | Example 10 | Example 11 | Example 12 |
| Concentration | 80 | 90 | 100 | 110 | 120 | 130 | 150 |
| degree | | | | | | | |
| (100 = 4.4 carats/cm²) | | | | | | | |
| Grain size | 100 | 100 | 100 | 100 | 100 | 100 | 100 |
| (abrasive | | | | | | | |
| grain size #) | | | | | | | |
| Grinding wheel | 120 | 120 | 120 | 120 | 120 | 120 | 120 |
| peripheral | | | | | | | |
| speed (m/s) | | | | | | | |
| Diamond | None | None | None | None | None | None | None |
| coating (Ti) | | | | | | | |

TABLE 3

| | Comparative | Comparative | Comparative | Comparative | Comparative | Comparative |
|---|---|---|---|---|---|---|
| | Example 13 | Example 14 | Example 15 | Example 16 | Example 17 | Example 18 |
| Concentration degree | 100 | 100 | 100 | 100 | 100 | 100 |
| (100 = 4.4 carats/cm²) | | | | | | |
| Grain size (abrasive | 150 | 120 | 100 | 80 | 60 | 40 |
| grain size #) | | | | | | |
| Grinding wheel | 120 | 120 | 120 | 120 | 120 | 120 |
| peripheral speed | | | | | | |
| (m/s) | | | | | | |
| Diamond coating (Ti) | None | None | None | None | None | None |

TABLE 4

| | Comparative | Comparative | Comparative | Comparative | Comparative | Comparative | Comparative |
|---|---|---|---|---|---|---|---|
| | Example 19 | Example 20 | Example 21 | Example 22 | Example 23 | Example 24 | Example 25 |
| Concentration | 100 | 100 | 100 | 100 | 100 | 100 | 100 |
| degree | | | | | | | |
| (100 = 4.4 carats/cm²) | | | | | | | |
| Grain size | 100 | 100 | 100 | 100 | 100 | 100 | 100 |
| (abrasive | | | | | | | |
| grain size #) | | | | | | | |
| Grinding wheel | 150 | 120 | 100 | 80 | 60 | 40 | 30 |
| peripheral | | | | | | | |
| speed (m/s) | | | | | | | |
| Diamond | None | None | None | None | None | None | None |
| coating (Ti) | | | | | | | |

TABLE 5

| | Example 1 | Example 2 | Example 3 | Example 4 | Example 5 | Example 6 | Example 7 |
|---|---|---|---|---|---|---|---|
| Concentration degree | 100 | 100 | 100 | 120 | 130 | 130 | 1300 |
| (100 = 4.4 carats/cm²) | | | | | | | |
| Grain size (abrasive | 100 | 80 | 80 | 80 | 100 | 80 | 80 |
| grain size #) | | | | | | | |
| Grinding wheel | 120 | 120 | 80 | 120 | 120 | 100 | 80 |
| peripheral speed | | | | | | | |
| (m/s) | | | | | | | |
| Diamond coating (Ti) | Present | Present | Present | Present | Present | Present | Present |

### EVALUATION

It is assumed that an amount (workable amount) of the honeycomb structure to be worked until the grinding member cannot be used is 100 in a case where the grinding member having specifications of Comparative Example 6 is used, performances (grindable amounts) of the grinding members in Examples 1 to 7 and Comparative Examples 1 to 25 are evaluated, and the results are shown in Table 6.

TABLE 6

| Comparative | Comparative | Comparative | Comparative | Comparative | Comparative | Comparative | Comparative |
|---|---|---|---|---|---|---|---|
| Example 1 | Example 2 | Example 3 | Example 4 | Example 5 | Example 6 | Example 7 | Example 8 |
| 70 | 80 | 80 | 60 | 70 | 100 | 100 | 120 |
| Comparative | Comparative | Comparative | Comparative | Comparative | Comparative | Comparative | Comparative |
| Example 9 | Example 10 | Example 11 | Example 12 | Example 13 | Example 14 | Example 15 | Example 16 |
| 120 | 130 | 150 | 170 | 180 | 100 | 100 | 120 |
| Comparative | Comparative | Comparative | Comparative | Comparative | Comparative | Comparative | Comparative |
| Example 17 | Example 18 | Example 19 | Example 20 | Example 21 | Example 22 | Example 23 | Example 24 |
| 120 | 130 | 130 | 130 | 100 | 120 | 120 | 130 |
| Comparative | | | | | | | |
| Example 25 | Example 1 | Example 2 | Example 3 | Example 4 | Example 5 | Example 6 | Example 7 |
| 140 | 430 | 460 | 450 | 450 | 460 | 460 | 470 |

It is seen from Table 6 that the workable amounts of Examples 1 to 7 are remarkably larger than those of the other comparative examples.

A method of manufacturing a honeycomb structure in the present invention is effectively utilized in various types of industrial fields for which a filter for trapping particulates in an exhaust gas is required.

What is claimed is:

1. A method of manufacturing a honeycomb structure, comprising the step of: working an outer periphery of a coarsely shaped honeycomb structure made of a porous ceramic by use of a grinding member including a grinding wheel layer in which diamond abrasive grains are contained and fixed in a bonding material having a predetermined shape to obtain the honeycomb structure having a predetermined shape,
wherein the diamond abrasive grains of the grinding member have a grain size of 40 to 150 mesh and a concentration degree of 80 or more, and the surfaces of the diamond abrasive grains are coated with at least one selected from the group consisting of Ti, Ni, and Cr.

2. The method of manufacturing the honeycomb structure according to claim 1, wherein the outer periphery of the coarsely shaped honeycomb structure is worked by a high-speed dry process at a rotation speed (peripheral speed) of 30 to 150 m/sec.

3. The method of manufacturing the honeycomb structure according to claim 1, further comprising the steps of:
obtaining a plurality of honeycomb segments in which a plurality of cells are arranged in a central axis direction of each honeycomb segment, the cells forming fluid channels defined by porous ceramic partition walls functioning as filters;
integrating the resultant plurality of honeycomb segments to obtain the coarsely shaped honeycomb structure; and
working the outer periphery of the resultant coarsely shaped honeycomb structure to obtain the honeycomb structure having the predetermined shape.

4. The method of manufacturing the honeycomb structure according to claim 1, wherein the outer periphery of the coarsely shaped honeycomb structure is worked by rotating the coarsely shaped honeycomb structure around a central axis of the structure, and pressing the grinding member onto an outer peripheral surface of the coarsely shaped honeycomb structure.

5. The method of manufacturing the honeycomb structure according to claim 1, wherein the outer periphery of the coarsely shaped honeycomb structure is worked so that a section of the structure cut along a plane perpendicular to the central axis of the structure is formed into a circular shape, an oblong shape, an elliptic shape, a triangular shape, a polygonal shape, or a shape obtained by transforming a part of one of these shapes.
